(19) United States
(12) Patent Application Publication
(10) Pub. No.: US 2018/0114982 A1
(43) Pub. Date: Apr. 26, 2018

(54) LITHIUM MANGANESE OXIDE SPINEL AND MANUFACTURING METHOD THEREFOR

(71) Applicant: Nano and Advanced Materials Institute Limited, Hong Kong (HK)

(72) Inventors: Yeming Xu, Hong Kong (HK); Quanda Zhang, Hong Kong (HK); Kwok Keung Paul Ho, Hong Kong (HK)

(21) Appl. No.: 15/331,934

(22) Filed: Oct. 24, 2016

(51) Int. Cl. H01M 4/505; C01G 45/12; H01M 10/0525

(52) U.S. Cl. CPC H01M 4/505; C01G 45/1235; C01P 2006/40; C01P 2002/32; H01M 10/0525

(57) ABSTRACT

Lithium manganese oxide material used in lithium ion battery is disclosed herein. The lithium manganese oxide material may be doped with suitable dopant. The lithium manganese oxide material may be represented by a first formula of Li₁₊ₓM_{y}Mn_{2-y-x}O₄, wherein the value of ‘x’, in the first formula, satisfies a relation −0.1<x<0.3 and the value of ‘y’, in the first formula, satisfies a relation a relation 0≤y≤0.2. The lithium manganese oxide material may further be coated with a shell capping layer. The shell capping layer may be made of a carbon or a compound having a second formula, Li₁₊ₓM_{y}Mn_{2-y-x}O₄. In an aspect, the value of ‘x’, in the second formula, may satisfy a relation −0.1<x<0.3. Further, the value of ‘y’, in the second formula, may satisfy a relation 0≤y≤0.2.

### TECHNICAL FIELD

The present application in general, relates to a lithium manganese oxide spinel, and more particularly, relates to a lithium manganese oxide spinel used in lithium-ion batteries.

### BACKGROUND

Lithium ion batteries are typically used in consumer electronics. Recently, the lithium ion batteries have become popular in varied applications including defence, automotive, and aerospace applications. The lithium ion batteries are mostly preferred because of their high energy-to-weight ratio and a slow loss of charge when not in use. Additionally, the lithium ion batteries have high energy and power density. Further, the lithium ion batteries are rechargeable and therefore reusable.

However, it has been observed that the lithium ion batteries require constant current and constant voltage for charging. The charge time of the lithium batteries depends upon type of application. Usually, the charge time of the lithium batteries is observed to be within a range of 1 to 5 hours. A lithium ion battery used in mobile phones or cell phones require 1C. Whereas, a lithium ion battery used in laptops require 0.8C. It is to be noted that “C” herein indicates a rated current that discharges the battery in one hour). Thus, the lithium ion batteries available today faces technical problems of slow charging and quick discharging. Hence, an improved lithium ion battery with high charging speed is desirable.

### SUMMARY

Before the present materials, compositions, systems and methodologies are described, it is to be understood that this application is not limited to the particular materials, compositions, systems and methodologies as described, as there can be multiple possible embodiments which are not expressly illustrated in the present application. It is also to be understood that the terminology used in the description is for the purpose of describing the particular versions or embodiments only, and is not intended to limit the scope of the present application. This summary is not intended to identify essential features of the claimed subject matter nor is it intended for use in detecting or limiting the scope of the claimed subject matter.

In one embodiment, a doped lithium manganese oxide material, optionally including a shell capping layer, is disclosed. The lithium manganese oxide material may be represented by a first formula of Li₁₊ₓM_{y}Mn_{2-y-x}O₄. In one aspect, the value of ‘x’, in the first formula, may satisfy a relation −0.1<x<0.3, preferably 0≤x≤0.15. Further, the value of ‘y’, in the first formula, may satisfy a relation 0≤y≤0.2, preferably 0≤y≤0.16. The lithium manganese oxide material may have a spinel structure. In an aspect, the metal element ‘M’ may include at least one of Cr, Al, Ni, Mg, V, Ca and a combination thereof. The metal element ‘M’ may exchange a position of ‘Mn’, in the formula, as a doping element. Further, the optionally included shell capping layer may be made of a carbon or a compound having a second formula of Li₁₊ₓM_{y}Mn_{2-y-x}O₄, wherein the value of ‘x’, in the second formula, satisfies a relation −0.1<x<0.3, and wherein the value of ‘y’, in the second formula, satisfies a relation 0≤y≤0.2.

In another embodiment, a method for preparation of a lithium manganese oxide, optionally including a shell capping layer, is disclosed. The method may include reacting a lithium compound, a manganese compound and a metal compound under conditions effective to produce a compound of a first formula of Li₁₊ₓM_{y}Mn_{2-y-x}O₄. In one aspect, the value of ‘x’, in the first formula, may satisfy the relation −0.1<x<0.3, preferably 0≤x≤0.15. Further, the value of ‘y’, in the first formula, may satisfy the relation 0≤y≤0.2, preferably 0≤y≤0.16. The conditions may include: mixing the lithium compound, the manganese compound and the metal compound in an aqueous solution thereby forming a mixture; spraying, through an atomizer, the mixture at a predefined temperature; collecting the sprayed powder precursor and calcinating the sprayed powder precursor in a furnace at one or more predefined temperature ranges for one or more predefined time intervals in air atmosphere to obtain calcinated powder. The method may further include optionally forming the shell capping layer on the surface of the calcinated powder by dispersing the calcinated powder into distilled water with a dissolved mixture of the lithium compound, the manganese compound and the metal compound; spray drying the dispersed solution at a predefined temperature; and calcinating the spray dried powder at a predefined temperature for a predefined time interval in the air atmosphere thereby forming a thin layer of compound with a second formula of Li₁₊ₓM_{y}Mn_{2-y-x}O₄ on the surface of the calcinated powder.

In yet another embodiment, a method for preparation of a lithium manganese oxide, optionally including a shell capping layer is disclosed. The method may include reacting a lithium compound, a manganese compound and a metal compound under conditions effective to produce a compound of a first formula of Li₁₊ₓM_{y}Mn_{2-y-x}O₄. In one aspect, the value of ‘x’, in the first formula, may satisfy the relation −0.1<x<0.3. Further, the value of ‘y’, in the first formula, may satisfy the relation 0≤y≤0.2. The conditions may include: mixing the lithium compound, the manganese compound and the metal compound in an aqueous solution thereby forming a mixture; spraying, through an atomizer, the mixture at a predefined temperature; collecting the sprayed powder precursor and calcinating the sprayed powder precursor in a furnace at one or more predefined temperature ranges for one or more predefined time intervals in air atmosphere to obtain calcinated powder. The method may further include optionally forming the shell capping layer on the surface of the calcinated powder by dispersing the calcinated powder into a mixture of distilled water and ethanol with a carbon precursor; concentrating the dispersed solution; calcinating the dried powder at a predefined temperature for a predefined time interval in the air atmosphere; and cooling the dried powder calcinated to form a thin layer of carbon on the surface of the calcinated powder.

### BRIEF DESCRIPTION OF THE DRAWINGS

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates an SEM image of aluminium-doped lithium manganese oxide (LMAO) cathode material prepared using spray pyrolysis process, in accordance with an embodiment of the present application.

FIG. 2 illustrates an XRD pattern of the LMAO cathode material prepared using the spray pyrolysis, in accordance with an embodiment of the present application.

FIG. 3 illustrates a charge-discharge cycling test of the LMAO cathode active materials prepared using the spray pyrolysis, in accordance with an embodiment of the present application.

FIG. 4 illustrates a charging rate performance test of the LMAO cathode active materials prepared using the spray pyrolysis with different calcination temperature (° C.), in accordance with an embodiment of the present application.

FIG. 5 illustrates SEM images 2% aluminium (Al) doped lithium manganese oxide (LMAO) cathode material prepared using solid state reaction at different calcination temperatures, in accordance with an embodiment of the present application.

FIG. 6 illustrates a charging rate capability of 2% aluminium (Al) doped lithium manganese oxide (LMAO) material calcinated at different temperatures, in accordance with an embodiment of the present application.

FIG. 7 illustrates SEM images of LMO and LMAO cathode materials prepared using the spray pyrolysis with different percentage of Al-dopant, in accordance with an embodiment of the present application.

FIG. 8 illustrates a charging rate performance test of LMO and LMAO cathode active materials prepared using the spray pyrolysis with different percentage of Al dopant, in accordance with an embodiment of the present application.

FIG. 9 illustrates SEM images of LMAO cathode materials prepared using the spray pyrolysis without and with LMO capping, in accordance with an embodiment of the present application.

FIG. 10 illustrates TEM images of the LMAO cathode materials prepared using the spray pyrolysis with LMO capping, in accordance with an embodiment of the present application.

FIG. 11 illustrates cycling performance of the LMAO cathode materials prepared using the spray pyrolysis with and without the LMO capping, in accordance with an embodiment of the present application.

### DETAILED DESCRIPTION

Some embodiments of this invention, illustrating all its features, will now be discussed in detail.

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described. The disclosed embodiments are merely exemplary of the invention, which may be embodied in various forms.

Various modifications to the embodiment will be readily apparent to those skilled in the art and the generic principles herein may be applied to other embodiments. However, one of ordinary skill in the art will readily recognize that the present application is not intended to be limited to the embodiments illustrated, but is to be accorded the widest scope consistent with the principles and features described herein.

In accordance with aspects of the present application, a lithium manganese oxide spinel material and method for manufacturing the said lithium manganese oxide spinel material are described herein. The lithium manganese oxide spinel material may act as a cathode active material in a lithium-ion battery used for charging different electronic applications. The battery may include a positive electrode (cathode), a negative electrode, a separator and an electrolyte. The cathode may include a current collector and an electrode active material layer. The electrode active material layer may include a cathode active material in a range of about 80-99%, cathode conductive agent in a range of about 0.1-10% and a cathode binder in a range of about 0.1-10%. The cathode active material may have a primary particle size in the range of about 50 nm to about 5 μm. Preferably, the primary particle size of the cathode active material may be in the range of about 200 nm to about 1 μm.

In order to prepare/manufacture a cathode active material, a lithium compound, a manganese compound and a metal compound may be mixed together in an aqueous solution thereby forming a mixture. The lithium compound may include at least one of Li₂O, LiOH, LiCl, LiNO₃, Li₂CO₃, lithium acetate, a Li-carboxylate and a combination thereof. The manganese compound may include at least one of MnO₂, MnO, MnOOH, Mn₂O₃, Mn₃O₄, MnCO₃, Mn(NO₃)₂, a Mn-carboxylate and a combination thereof. The metal compound may include at least one of a metal salt, a metal hydroxide, a metal carboxylate and a combination thereof. The metal element of the metal compound may include at least one of Cr, Al, Ni, Mg, V, Ca and a combination thereof. The mixture may include a molar portion of the lithium compound, the manganese compound and the metal compound in a predefined range of about 0.9 to about 1.2, about 1.70 to about 2.1, and about 0 to about 0.2 respectively. Preferably, the molar portion of the lithium compound, the manganese compound and the metal compound may be within a range of about 1.0 to about 1.15, about 1.75 to about 2.0 and about 0.01 to about 0.16 respectively. Further the mixture may be sprayed, through an atomizer, at a predefined temperature in a range of about 80° C. to about 250° C. The sprayed mixture may be calcinated at a predefined temperature range of about 400° C. to about 500° C. for a first time interval of around 30 minutes to around 2 hours. The sprayed powder precursor may further be calcinated at a second predefined temperature range of about 700° C.-1000° C. for a second predefined time interval of around 5 hours to around 40 hours. Preferably, the sprayed mixture may be calcinated at a temperature range of about 750° C.-950° C. for a time interval of around 10 hours to around 30 hours. After calcination, a compound having a formula Li₁₊ₓM_{y}Mn_{2-y-x}O₄ may be produced. In one aspect, the value of ‘x’ may satisfy the relation −0.1<x<0.3 and the value of y may satisfy the relation 0≤y≤0.2. Preferably the value of ‘x’ and ‘y’ may satisfy the relation 0≤x≤0.15 and 0≤y≤0.16 respectively.

In order to prepare/manufacture a cathode active material with a shell capping layer, a lithium compound, a manganese compound and a metal compound may be mixed together in an aqueous solution thereby forming a mixture. The lithium compound may include at least one of Li₂O, LiOH, LiCl, LiNO₃, Li₂CO₃, lithium acetate, a Li-carboxylate and a combination thereof. The manganese compound may include at least one of MnO₂, MnO, MnOOH, Mn₂O₃, Mn₃O₄, MnCO₃, Mn(NO₃)₂, a Mn-carboxylate and a combination thereof. The metal compound may include at least one of a metal salt, a metal hydroxide, a metal carboxylate and a combination thereof. The metal element of the metal compound may include at least one of Cr, Al, Ni, Mg, V, Ca and a combination thereof. The mixture may include a molar portion of the lithium compound, the manganese compound and the metal compound in a predefined range of about 0.9 to about 1.2, about 1.70 to about 2.05, and about 0 to about 0.2 respectively. Preferably, the molar portion of the lithium compound, manganese compound and the metal compound may be within a range of about 1.0 to about 1.15, about 1.75 to about 2.0 and about 0.01 to about 0.16 respectively. Further the mixture may be sprayed, through an atomizer, at a predefined temperature in a range of about 80° C. to about 250° C. The sprayed mixture may be calcinated at a predefined temperature range of about 400° C. to about 500° C. for a first time interval of around 30 minutes to around 2 hours. The sprayed powder precursor may further be calcinated at a second predefined temperature range of about 700° C.-1000° C. for a second predefined time interval of around 5 hours to around 40 hours. Preferably, the sprayed mixture may be calcinated at a temperature range of about 700° C.-900° C. for a time interval of around 5 hours to around 20 hours. After calcination, a compound (i.e. a calcinated powder) having a formula Li₁₊ₓM_{y}Mn_{2-y-x}O₄ may be produced. In one aspect, the value of ‘x’ may satisfy the relation −0.1<x<0.3 and the value of y may satisfy the relation 0≤y≤0.2. Preferably the value of ‘x’ and ‘y’ may satisfy the relation 0≤x≤0.15 and 0≤y≤0.16 respectively. Further, the calcinated powder may be optionally coated with either a compound layer or a carbon layer.

In one embodiment, in order to coat the calcinated powder with the compound layer, the calcinated powder may be dispersed into distilled water with a dissolved mixture of the lithium compound, the manganese compound and the aluminium compound. It is to be noted that the molar portion of the lithium compound is in the range of about 0.9 to about 1.15 (preferred range is about 1.0 to about 1.1), the molar portion of manganese compound is in the range of about 1.70 to about 2.05 (preferred range is about 1.75 to about 2.0), and the molar portion of aluminum compound is in the range of about 0 to about 0.2 (preferred range is about 0.01 to about 0.16). The dispersed solution may further be spray dried at a predefined temperature range of about 80° C.-250° C. and calcinated at about 500° C.-1000° C. in air atmosphere. A thin layer of a compound, acting as the shell capping layer, having the formula Li₁₊ₓM_{y}Mn_{2-y-x}O₄, may be formed on the surface of calcinated powder.

In another embodiment, in order to coat the calcinated powder with the carbon layer, the calcinated powder may be dispersed into a mixture of distilled water and ethanol with a carbon precursor. The carbon precursor may be at least one of a glucose, a sucrose and a combination thereof. The dispersed solution may be allowed to concentrate. Thereafter, dried powder may be calcinated at a predefined temperature of about 600° C. for around ten minutes. After cooling to room temperature, a thin layer of carbon, acting as the shell capping layer, may be formed on the surface of calcinated powder.

In an embodiment, the thickness of the shell capping layer formed on the cathode active material may be within a range of about 1 nm to about 20 nm. Preferably, the thickness of the shell capping layer is about 5 to about 15 nm. The cathode active material as described above may be prepared/fabricated using synthesis process such as a spray pyrolysis or a solid state reaction, the details of which are described below.

In one embodiment, the preparation/fabrication of the cathode active material using spray pyrolysis process is described. The system employed for carrying out the spray pyrolysis process may include a droplet generator, a quartz reactor, and a particle collector. In this embodiment, the cathode active material such as aluminum doped lithium manganese oxide with formula of Li_{1.09}Al_{0.04}Mn_{1.87}.O₄ (LMAO) may be prepared by using an aqueous solution of a manganese acetate and a lithium acetate. Specifically, the manganese acetate and the lithium acetate may be mixed together in an aqueous solution thereby forming a mixture. The mixture may be further sprayed through an atomizer (e.g. an ultrasonic spray head) at a predefined temperature. The resulting mist/spray powder precursor may be dried and further collected by the particle collector. The dried solid powder may be calcinated in an air filled furnace at a predefined temperature for a predefined time in order to obtain Li_{1.09}Al_{0.04}Mn_{1.87}.O₄ (LMAO) as the cathode active material. The furnace used for calcinating the mixture may be a muffle furnace or a rotary furnace. The calcination of the sprayed powder precursor may be carried out at a predefined temperature within a range of about 400° C. to about 500° C. for a predefined time of around 30 minutes to around 2 hours. Additionally, the sprayed powder precursor may be further calcinated at a predefined temperature within a range of about 700° C.-1000° C. for a predefined time of around 5 hours to around 40 hours. The calcination may be carried out in air atmosphere.

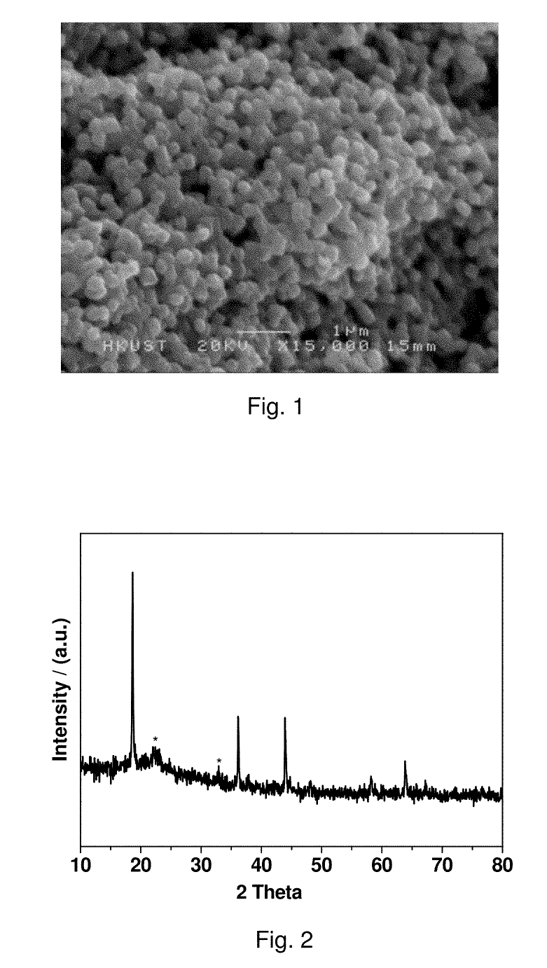

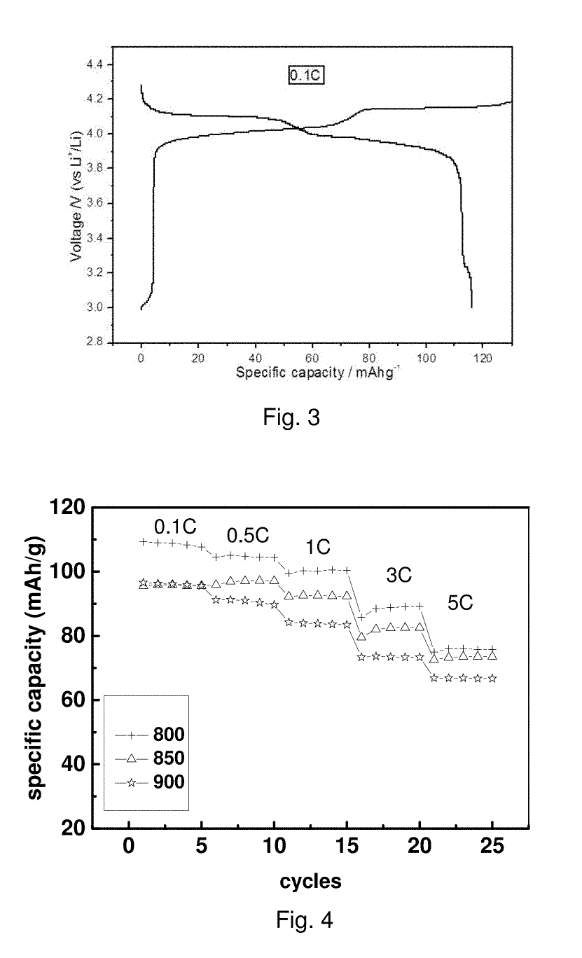

Thus, after the calcination of the sprayed powder precursor at different temperatures for different time periods, an Aluminum-doped Lithium Manganese Oxide (LMAO) cathode active material having the compound formula Li_{1.09}Al_{0.04}Mn_{1.87}O₄ (LMAO) is obtained. FIG. 1 illustrates an SEM image of the Aluminium-doped Lithium Manganese Oxide (LMAO) cathode material prepared using spray pyrolysis process. As can be seen from FIG. 1, the primary particle size of LMAO cathode active material prepared using the spray pyrolysis is about 200 nm. The EDX analysis as depicted in Table 1 of LMO indicates that there is no elemental contamination in the synthetic process. FIG. 2 illustrates an XRD pattern of the LMAO cathode material prepared using the spray pyrolysis process. As depicted in FIG. 2, the LMAO prepared using the spray pyrolysis synthesis process is having a spinel structure (e.g. JCPS card No. 35-0782). Further, it can be observed from FIG. 3, that the crystallinity of LMO/LMAO is better as compared to LMO/LMAO prepared from the other methods such as solution-based precipitation, hydrothermal reaction, and sol-gel reaction, etc.

FIG. 3 illustrates a charge-discharge cycling test of the LMAO cathode active materials prepared using the spray pyrolysis process. As depicted in FIG. 3, the specific capacity of the LAMO cathode active material prepared using spray pyrolysis is about 114 mAh/g at 0.1C. In order to further improve the crystallinity as well as the performance of LMO/LMAO cathode materials, the sprayed powder precursors may be calcinated at about 700° C., about 750° C., about 800° C., about 850° C., about 900° C., about 950° C. (preferably at about 800-900° C.). The calcination at these temperatures (i.e. at 700° C., 750° C., 800° C., 850° C., 900° C., 950° C.) results in improved rate capability as can be seen from FIG. 4. The lithium manganese oxide obtained after calcination has a primary particle size of about 50 nm to about 5 μm, preferably in the range of about 200 nm to about 1 μm. The primary particles grow together during calcination process to form large secondary particles with secondary particle size in the range of about 10-30 μm.

In one example, 11.09 molar portion of lithium acetate, 1.91 to 1.75 molar portion of manganese acetate and 0 to 0.16 molar portion of Al(OH)₃ may be dissolved in water with vigorous stirring for around 15 minutes. Further, the solution may be pumped to an atomizer and sprayed out at about 120° C. to form fine particles. The dried particles may be collected and pretreated at about 450° C. for around 2 hours and calcinated at 800-900° C. for 20-40 hours. A lithium ion battery cathode active material may be obtained with the formula of Li_{1.09}Mn_{1.91-x}AlₓO₄ (0≤x≤0.16) and having a particle size ranging from 200 to 400 nm. FIG. 1 to FIG. 4 and FIG. 7 to FIG. 8 illustrates the prepared cathode material calcinated at 800-900° C. with different doping ratio. The doping ratio in the figure is the portion of x over 1.91 (e.g., 2%=0.04/1.91).

In another embodiment, the preparation/fabrication of a cathode active material using a solid state reaction process is described. In this embodiment, the cathode active material such as metal doped lithium manganese oxide is prepared using solid mixing of a lithium salt, a manganese oxide powder and a doping element. In one aspect, the lithium salt is at least one of lithium carbonate, lithium hydroxide or lithium acetate. Further, the doping element may be selected from metal oxides, or salts or hydroxides. In order to obtain the metal doped lithium manganese oxide, the mixture of the lithium salt, the manganese oxide powder and the doping element may be calcinated in an air filled furnace. Specifically, the mixture may be calcinated at a predefined temperature of about 450° C. for a predefined time of around 2 hours. Additionally, the mixture may be further calcinated at a higher predefined temperature of about 750° C.-950° C. for a predefined longer time period of around 10 to 40 hours. The calcination may result in obtaining the metal doped lithium manganese oxide.

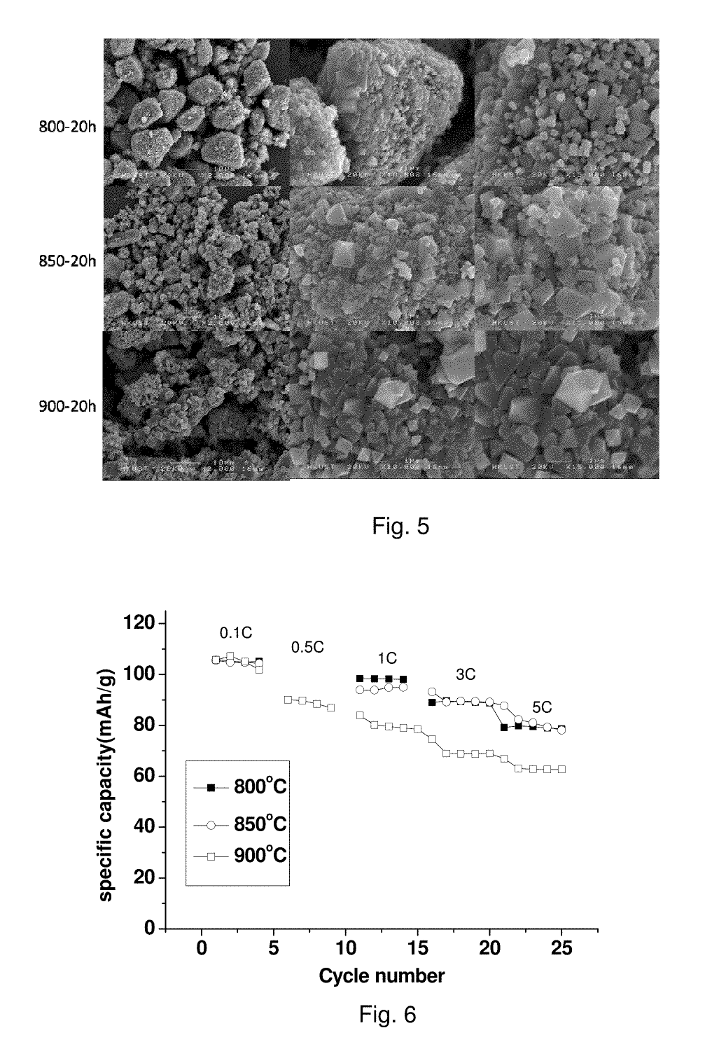

FIG. 5 illustrates SEM images of 2% aluminium (Al) doped lithium manganese oxide (LMAO) cathode material prepared using solid state reaction at different calcination temperatures. As can be seen from FIG. 5, it is observed that the primary particle size (i.e. crystal size) of the cathode material is increased from 200-400 nm (800° C.) to 500-800 nm (850° C.) and 1 μm (900° C.) with the increase in the calcination temperature. However, it is to be noted that the rate capability is decreased with the increase in the calcination temperature from 800° C. to 900° C. FIG. 6 illustrates the charging rate capability of 2% aluminium (Al) doped lithium manganese oxide (LMAO) material calcinated at different temperatures. As shown in FIG. 6, the charging rate capability is reduced with the increase in the calcination temperature from 800° C. to 900° C. It is to be noted that the charging rate capability is reduced with the increase in the calcination temperature because the larger crystal size limits the lithium diffusion in the crystal.

In one example, 1.09 molar portion of lithium carbonate, 1.91 to 1.75 molar portion of electrolytic manganese dioxide and 0 to 0.16 molar portion of Al(OH)₃ may be mixed either using blender or ball miller. The mixed precursor may be transferred into a muffle furnace or a rotary tube furnace and pretreated at 450° C. for 2 hours. The mixture may be calcinated at 700° C.-950° C. for 20-40 hours at air atmosphere. A lithium ion battery cathode active material may be obtained with the formula of Li_{1.09}Mn_{1.91-x}AlₓO₄ having a particle size within a range of 200 to 1000 nm. FIG. 5 and FIG. 6 illustrate the morphology and rate performance of the prepared cathode materials calcinated at 800-900° C.

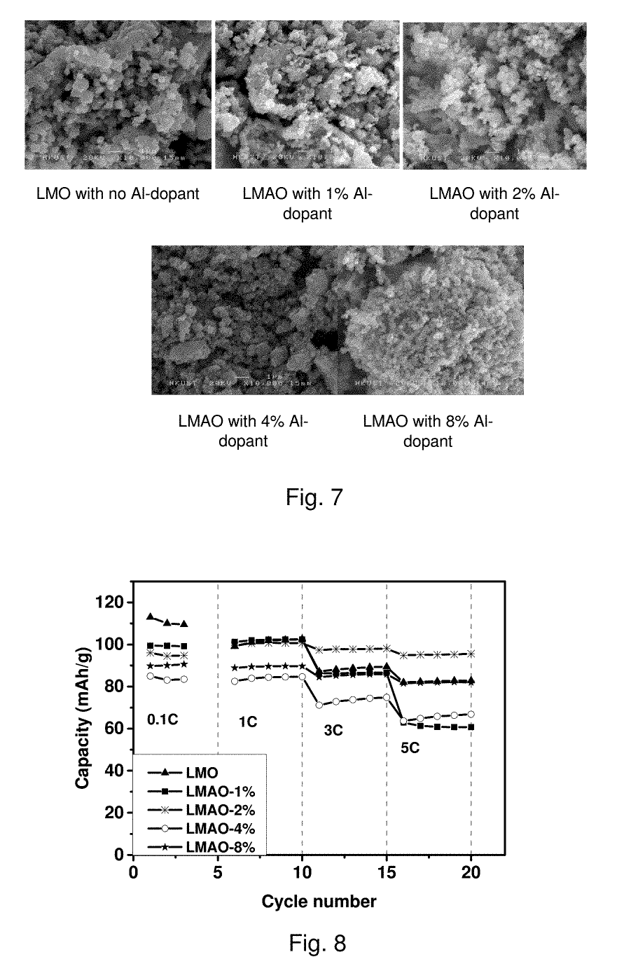

In yet another embodiment, aluminum-doping on the cathode active material is described. In this embodiment, the Al-doped cathode active material is prepared using either of the spray pyrolysis process or the solid state reaction process as described above. In accordance with this embodiment, the cathode active material such as LMO may be doped with aluminum (Al) material to form an Al-doped LMO or LMAO. FIG. 7 illustrates SEM images of LMO and LMAO cathode materials prepared using the spray pyrolysis process with different percentage of Al-dopant. As can be seen from FIG. 7, the particle size of the Al-doped LMO or the LMAO is within a range of 100 nm to 1 μm. Further, it is observed that the solid powder with 2% Al provides relatively even size particles having a particle size of 200 nm to 300 nm. Referring to FIG. 8, it is observed that 2% Al-doped cathode material depicts better rate capability during cycling as compared to other doped cathode materials having different percentage of Al-dopant. As can be seen from FIG. 8, the specific capacity obtained for 2% Al-doped cathode active material even at 5C charging rate is 96 mAh/g.

In accordance with aspects of the present application, a lithium manganese oxide material with a shell capping layer and a method for manufacturing the said lithium manganese oxide material with the shell capping layer is described. In one embodiment, the cathode active material may be further coated with a lithium manganate (LMO) coating. The coating of LMO on the cathode active materials such as LMAO may be achieved by mixing an aqueous solution of as-prepared LMAO and a mixture of lithium acetate and manganese acetate. The mixture may be further atomized with an ultrasonic spray head and a resulting mist may be dried and further collected in the particle collector. The dry solid powder may be calcinated in air filled muffle furnace at a temperature of 800° C. in order to form LMO-coated LMAO.

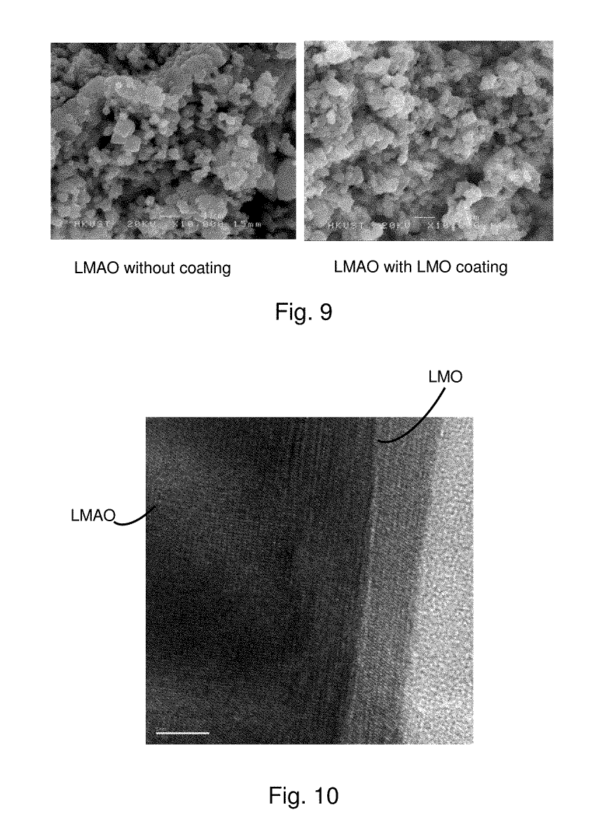

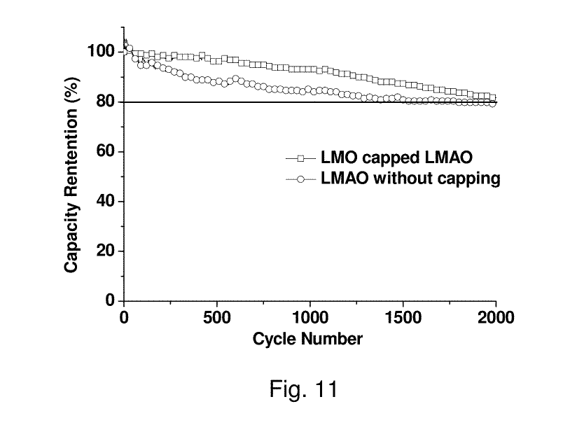

FIG. 9 illustrates SEM images of LMAO cathode materials prepared using the spray pyrolysis without and with LMO capping, in accordance with an embodiment of the present application. As can be observed from FIG. 9, the size of the LMAO (without capping/coating) and the LMAO coated with LMO (i.e. with capping/coating) is within a range of 100 nm to 200 nm. FIG. 10 illustrates TEM images of the LMAO cathode materials prepared using the spray pyrolysis with LMO capping. As observed from FIG. 10, the thickness of the LMAO layer is about 5 nm. FIG. 11 illustrates cycling performance of the LMAO cathode materials prepared using the spray pyrolysis with and without the LMO capping. As can be seen from FIG. 11, it is observed that the LMAO coated with LMO illustrates improvement in stability of the LMAO cathode material due to presence of surface coating in form of LMO capped layer.

10040 In one example, an Al doped lithium manganese oxide active material may be dispersed into water with lithium acetate, manganese acetate mixture in a ratio of 1.09:1.91. The solution may be pumped to an atomizer and sprayed out at 120° C. The LMO precursors may be coated onto LMAO particle surface. The dried particles may be collected and pretreated at 450° C. for 2 hours. Further, the particles penetrated may be calcinated at 700° C.-950° C. for 20-40 hours at air atmosphere to obtain an LMO-coated LMAO. FIG. 9 and FIG. 10 illustrate the morphology and cycle performance comparison of the LMAO cathode with LMO coating layer and the LMAO cathode without the LMO coating layer.

In another embodiment, instead of the LMO coating as described above, the cathode active material may be capped/coated with a carbon. In this embodiment, 3 g previously prepared LMO powder may be dispersed in a distilled water and ethanol solvent having a volume ratio of 1:3. Further, 526 g glucose (or 0.5 g sucrose) may be dissolved in the water and then poured into the LMO dispersion liquid. After ultrasonication for predefined time interval, the solution may be concentrated to obtain a dry powder. The dry powder may further be calcinated at 600° C. for ten minutes and thereafter cooled to room temperature in order to obtain carbon coated LMO.

Table 1 below illustrates the rate performance and capacity retention of LMO and LMAO cathode materials, in accordance with embodiments of the present application.

TABLE 1
Rate performance and capacity retention of LMO and LMAO
cathode materials.

| | | | | | | Capacity | | |
|---|---|---|---|---|---|---|---|---|
| | | | | | | retention (%) at different | | |
| | | Specific capacity | | | | charge-discharge cycles | | |
| | | (mAh/g) at different | | | | 5 C, | 5 C, | 5 C, |
| | Doping | charge rate (C) | | | | 100 | 200 | 800 |
| Sample | leve1 | 0.1 C | 1 C | 3 C | 5 C | cycles | cycles | cycles |
| LMO | 0 | 115 | 102 | 89 | 85 | 100% | 94% | 67% |
| LMAO-1 | 1% | 99 | 102 | 86 | 60 | 67% | 53% | 35% |
| LMAO-2 | 2% | 108 | 106 | 101 | 96 | 100% | 94% | 88% |
| LMAO-3 | 4% | 82 | 85 | 75 | 72 | 99% | 100% | 84% |
| LMAO-4 | 8% | 90.6 | 89 | 86 | 82 | 100% | 98% | 88% |

The embodiments, examples and alternatives of the preceding paragraphs or the description and drawings, including any of their various aspects or respective individual features, may be taken independently or in any combination. Features described in connection with one embodiment are applicable to all embodiments, unless such features are incompatible.

Although implementations of lithium manganese oxide spinel materials and manufacturing methods therefor have been described in language specific to structural features and/or methods, it is to be understood that the appended claims are not necessarily limited to the specific features or methods described. Rather, the specific features and methods are disclosed as examples of implementations lithium manganese oxide spinel materials and manufacturing methods therefor.

What is claimed is:

1. A lithium manganese oxide material having a first formula of Li₁₊ₓM_{y}Mn_{2-y-x}O₄, wherein:
the value of ‘x’, in the first formula, satisfies a relation −0.1<x<0.3, and preferably 0≤x≤0.15;
the value of ‘y’, in the first formula, satisfies a relation 0≤y≤0.2, and preferably 0≤y≤0.16;
M comprises a metal selected from at least one of Cr, Al, Ni, Mg, V, Ca and a combination thereof; and
the lithium manganese oxide material has a spinel structure.

2. The lithium manganese oxide material of claim 1, wherein the lithium manganese oxide material has a primary particle size of 50 nm to 5 μm, preferably in the range of 200 nm to 1 μm.

3. The lithium manganese oxide material of claim 1 further comprising a shell capping layer containing carbon or a compound having a second formula of Li₁₊ₓM_{y}Mn_{2-y-x}O₄, wherein the value of ‘x’, in the second formula, satisfies a relation −0.1<x<0.3, and the value of ‘y’, in the second formula, satisfies a relation 0≤y≤0.2.

4. The lithium manganese oxide material of claim 3, wherein thickness of the shell capping layer is in a predefined range of 1 nm to 20 nm, preferably 5 nm to 15 nm.

5. A method for preparation of a lithium manganese oxide, comprising:
reacting a first lithium compound, a first manganese compound and a first metal compound under conditions effective to produce a compound having a first formula of Li₁₊ₓM_{y}Mn_{2-y-x}O₄, wherein:
the value of ‘x’, in the first formula, satisfies a relation −0.1<x<0.3, and preferably 0≤x≤0.15;
the value of ‘y’, in the first formula, satisfies a relation 0≤y≤0.2, and preferably 0≤y≤0.16; and
the conditions comprises:
mixing the first lithium compound, the first manganese compound and the first metal compound in an aqueous solution thereby forming a mixture;
spraying, through an atomizer, the mixture at a predefined temperature;
collecting the sprayed powder precursor; and
calcinating the sprayed powder precursor in a furnace at one or more predefined temperature ranges for one or more predefined time intervals in air atmosphere to obtain calcinated powder.

6. The method of claim 5, wherein a molar portion of the first lithium compound, the first manganese compound and the first metal compound mixed in an aqueous solution is in a predefined range of 0.9 to 1.2, 1.70 to 2.1, and 0 to 0.2 respectively.

7. The method of claim 5, wherein the first lithium compound comprises at least one member selected from Li₂O, LiOH, LiCl, LiNO₃, Li₂CO₃, lithium acetate and a Li carboxylate.

8. The method of claim 5, wherein the first manganese compound comprises at least one member selected from MnO₂, MnO, MnOOH, Mn₂O₃, Mn₃O₄, MnCO₃, Mn(NO₃)₂, and a Mn-carboxylate.

9. The method of claim 5, wherein the first metal compound comprises at least one member selected from a metal salt, a metal hydroxide and a metal carboxylate, wherein the metal comprises at least one member selected from Cr, Al, Ni, Fe and Co.

10. The method of claim 5, wherein the mixture is sprayed at a predefined temperature within a range of 80° C. to 250° C.

11. The method of claim 5, wherein the sprayed powder precursor is calcinated at a first predefined temperature range of 400° C. to 500° C. for a first predefined time interval of 30 minutes to 2 hours.

12. The method of claim 5, wherein the sprayed powder precursor is further calcinated at a second predefined temperature range of 700° C. to 1000° C. for a second predefined time interval of 5 hours to 40 hours.

13. The method of claim 5 further comprising forming a shell capping layer on the surface of the calcinated powder.

14. The method of claim 13, wherein the shell capping layer is formed by the following steps:
dispersing the calcinated powder into distilled water containing a dissolved mixture of a second lithium compound, a second manganese compound and a second metal compound;
spray drying the dispersed solution at a predefined temperature; and
calcinating the spray dried powder at a predefined temperature range for a predefined time interval in the air atmosphere thereby forming a thin layer of compound, having a second formula of Li₁₊ₓM_{y}Mn_{2-y-x}O₄, on the surface of the calcinated powder; wherein:
the value of ‘x’, in the second formula, satisfies a relation −0.1<x<0.3, and preferably 0≤x≤0.15;
the value of ‘y’, in the second formula, satisfies a relation 0≤y≤0.2, and preferably 0≤y≤0.16;
the second lithium compound comprises at least one member selected from Li₂O, LiOH, LiCl, LiNO₃, Li₂CO₃, lithium acetate and a Li carboxylate;
the second manganese compound comprises at least one member selected from MnO₂, MnO, MnOOH, Mn₂O₃, Mn₃O₄, MnCO₃, Mn(NO₃)₂, and a Mn-carboxylate; and
the second metal compound comprises at least one member selected from a metal salt, a metal hydroxide and a metal carboxylate, wherein the metal comprises at least one member selected from Cr, Al, Ni, Fe and Co.

15. The method of claim 14, wherein a molar portion of the second lithium compound, the second manganese compound and the second metal compound mixed in an aqueous solution is in a predefined range of 0.9 to 1.15, 1.70 to 2.05, and 0 to 0.2 respectively.

16. The method of claim 14, wherein the dispersed solution is spray dried at a predefined temperature within a range of 80° C. to 250° C.

17. The method of claim 14, wherein the spray dried powder is calcinated at a predefined temperature range of 500° C.-1000° C.

18. The method of claim 13, wherein the shell capping layer is formed by the following steps:
dispersing the calcinated powder into a mixture of distilled water and ethanol with a carbon precursor;
concentrating the dispersed solution;
calcinating the dried powder at a predefined temperature range for a predefined time interval in the air atmosphere; and
cooling the dried powder calcinated to form a thin layer of carbon on the surface of the calcinated powder.

19. The method of claim 18, wherein the dried powder is calcinated at the predefined temperature range of 600° C. for a predefined time interval of ten minutes.

20. The method of claim 18, wherein the carbon precursor comprises at least one member selected from glucose and sucrose.
